(19) United States
(12) Patent Application Publication
(10) Pub. No.: US 2010/0091900 A1
(43) Pub. Date: Apr. 15, 2010

(54) APPARATUS AND METHOD FOR OFDM MODULATED SIGNAL TRANSMISSION WITH REDUCED PEAK-TO-AVERAGE POWER RATIO

(75) Inventor: Hong Gan, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/575,828

(22) Filed: Oct. 8, 2009

Related U.S. Application Data
(60) Provisional application No. 61/104,489, filed on Oct. 10, 2008.
(60) Provisional application No. 61/229,885, filed on Jul. 30, 2009.

(51) Int. Cl. H04L 27/28; H04B 7/02

(52) U.S. Cl. 375/267; 375/260

(57) ABSTRACT

An apparatus and method for reducing peak-to-average power ratio (PAPR) in orthogonal frequency division multiplex (OFDM) comprising forming a plurality of OFDM frequency domain subcarriers; mapping the plurality of OFDM frequency domain subcarriers into a plurality of subset subcarriers; converting the plurality of subset subcarriers into a plurality of time domain subwaveforms; recombining the plurality of time domain subwaveforms into two or more time domain combined signals with low Peak-to-Average Power Ratio (PAPR); and frequency upconverting the two or more time domain combined signals to obtain a transmit signal.

### CLAIM OF PRIORITY UNDER 35 U.S.C. §119

The present Application for Patent claims priority to Provisional Application No. 61/104,489 entitled “Method and Apparatus for OFDM Modulated Signal Transmission With Reduced Peak-to-Average Power Ratio (PAPR)” filed Oct. 10, 2008, and assigned to the assignee hereof and hereby expressly incorporated by reference herein. The present Application for Patent also claims priority to Provisional Application No. 61/229,885 entitled “Method and Apparatus for OFDM Modulated Signal Transmission With Reduced Peak-to-Average Power Ratio” filed Jul. 30, 2009, and assigned to the assignee hereof and hereby expressly incorporated by reference herein.

### FIELD

This disclosure relates generally to wireless communications systems. More particularly, the disclosure relates to reducing peak-to-average power ratio (PAPR) in an orthogonal frequency division multiplex (OFDM) communication system.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, 3GPP2 Ultra Mobile Broadband (UMB) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (FL) (or downlink (DL)) refers to the communication link from the base stations to the terminals, and the reverse link (RL) (or uplink (UL)) refers to the communication link from the terminals to the base stations. This communication link may be established via a single-input-single-output (SISO), multiple-input-single-output (MISO), single-input-multiple-output (SIMO), or a multiple-input-multiple-output (MIMO), or an antenna array system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system supports time division duplex (TDD) and frequency division duplex (FDD) systems. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

Orthogonal frequency division multiplex (OFDM) transmission is a multicarrier transmission technique which greatly simplifies operation in a multipath environment. OFDM waveforms are more resistant to multipath distortion since a single high rate data stream is spread onto a plurality of lower rate transmission symbols which are mutually orthogonal.

One problem that restricts OFDM usage in some applications is its inherent high peak-to-average power ratio (PAPR). One challenge of optimizing OFDM performance in a nonlinear transmission environment has attracted significant research in developing solutions that can reduce the PAPR while still maintaining the major advantages of OFDM signal characteristics.

Publications have proposed techniques of solving PAPR problems for OFDM based systems. In general, these techniques can be classified into two categories. The first is in the digital domain that modifies the OFDM waveform to achieve reduced PAPR signals for transmission. The second is in the RF analog front end domain that aims to extend the transmission linearity and increase efficiency.

Known techniques in the digital domain for solving the PAPR problems include: clipping, non-linear companding transforms, coding schemes, partial transmit sequence (PTS) and selective mapping (SLM), adding active subcarriers, etc. Known techniques in the RF analog domain for solving the PAPR problems include: feed forward, pre-distortion and feedback linearization, Doherty amplification technique, linear amplification with nonlinear components (LINC) technology, Envelope Elimination & Restoration (EE&R) and Envelope Tracking Approach, digital polar and RF DAC, etc. Each of the mentioned known techniques for solving PAPR problems is briefly discussed below.

In digital baseband, five conventional approaches are discussed herein: clipping, nonlinear companding transforms, coding schemes, partial transmit sequence (PTS) and selective mapping (SLM), and adding active subcarriers technique. Clipping is an approach which removes the signals above a predefined signal level and protects the hardware. It requires no signal recovery but results in signal quality degradation and spectrum re-growth.

Nonlinear companding transform technique applies a nonlinear function to the OFDM signal that enlarges the weak signals and compresses large signals which results in increased average power and reduced PAPR. Nonlinear functions include the μ-law algorithm and error and exponential transform. Disadvantages of the nonlinear companding transform technique include additional nonlinear distortion noise, addition of frequency spurs, and the need for a nonlinear receiver. One prior art example of a companded multicarrier modulation (MCM) system with iterative receiver is shown in FIG. 10.

Coding schemes reduce the probability of in-phase subcarriers, using such codes as Simple Odd Parity Code (SOPC), Complement Block Coding (CBC), and Golay complementary sequences. However, the PAPR reduction from coding includes the disadvantage of coding rate loss.

In partial transmit sequence (PTS), the input data are partitioned into frequency domain sub-blocks. Then the sub-blocks are converted into the time domain as partial sequences. The partial sequences are independently rotated by M phase factors. Optimization is conducted to search for the best phase function. The transmitted signal is the signal with the best phase rotation. FIGS. 11 and 12 show the phase rotation function. In particular, FIG. 11 shows a prior art example block diagram of the PTS technique. And, FIG. 12 shows a prior art example block diagram of the SLM technique. Disadvantages of the Partial transmit sequence (PTS) and Selective mapping (SLM) technique include high computational complexity, the overhead transmission of the phase shift functions, and added receiver complexity for the correct bit decoding.

In the “adding active subcarriers” technique, the idea is to add a waveform with certain properties to the composite transmit signal. The iterative algorithm constructs this waveform so that it has sharp and unique peaks in counter phase to the largest peak(s) of each OFDM symbols, as shown in the FIG. 13. The optimal searched waveforms are transmitted in reserved subcarriers. Disadvantages of the adding active subcarriers technique include the computational complexity for the search of the optimal waveform and the spectral efficiency reduction of the OFDM system. Also, the technique adds receiver complexity.

Research and design efforts over several decades have aimed to develop linear and high efficiency power amplifiers and transmission systems to improve power added efficiency and linearity, using such techniques as digital pre-distortion, harmonic tuning, Doherty amplification, feedback and feed forward amplification, envelope elimination and restoration (EE&R), and linear amplifier with nonlinear components (LINC). Examples of RF/analog approaches are discussed herein.

Feed forward is mainly used to improve the linearity of power amplifiers where extremely high linearity is required, such as in CDMA base stations. The feed forward technique utilizes active open loop intermodulation cancellation approach to achieve high linearity, using a system that includes a main amplifier, an error amplifier, and a coupling and synchronization scheme. Disadvantages of the feed forward technique include added current consumption and added system complexity.

Pre-distortion is an analog and/or digital correction approach to improve linearity where power amplifiers are allowed to work in weak nonlinear mode. This approach utilizes a priori nonlinear characteristic of the power amplifier and/or adaptive feedback scheme to compensate for amplitude to amplitude (AM/AM) and amplitude to phase (AM/PM) distortion due to no linearity of the power amplifier devices. FIG. 14 illustrates an example block diagram of pre-distortion linearizer with feedback amplification. The pre-distortion algorithm combines the a priori nonlinear characteristic with detected output distortion to adjust the input signal such that the output distortion is minimized.

The Doherty amplifier was first proposed in 1936 by W. H. Doherty. It has been classified as a variation of push pull power amplifier in that the compensative amplifier is not 180 degrees out of phase but conducts in-phase amplitude compensation by an auxiliary amplifier while the main amplifier is saturated. The Doherty amplifier consists of main and auxiliary amplifiers with their outputs connected by a quarter-wave transmission line. There is a quarter-wave transmission line at the input of the auxiliary amplifier to compensate for the equivalent delay at the output. The main amplifier is typically biased class B and the auxiliary amplifier is typically biased class C, so that the auxiliary amplifier turns on at the power when the main amplifier reaches saturation.

The current contribution from the auxiliary amplifier reduces the effective impedance seen at the main amplifier's output. This “load-pulling” effect allows the main amplifier to deliver more current to the load while it remains saturated. Since an amplifier in saturation typically operates very efficiently, the total efficiency of the system remains high in this high-power range until the auxiliary amplifier saturates. The auxiliary amplifier could also be expanded to multistage called N-way Doherty amplifier as shown in FIG. 15 to enhance the efficiency over wide dynamic range. FIG. 16 shows the improvement of the efficiency in ideal conditions.

LINC (linear amplification with nonlinear components) technology was introduced by D. C. Cox in middle 1970s. LINC makes use of available nonlinear amplifiers or phase-lockable oscillators to produce bandpass linear amplification with nonlinear components. The overall input-to-output transfer function of a LINC amplifier is linear over a wide range of input signal levels but the internal RF amplifying devices can be highly nonlinear or, in fact, even constant-amplitude phase-locked oscillators. The basic principle of the LINC system is separating the bandpass input signal that may have either or both amplitude and phase (frequency) variations into two componential signals, s1 and s2, that are constant amplitude with variations in phase only.

Any amplifier with sufficient bandwidth, regardless of its amplitude linearity, can amplify these two constant-amplitude phase-modulated signals. Separately, the amplified component signals are passively combined to produce an amplified replica of the input signal. FIG. 17 shows an example block diagram of a LINC amplifier. More recent design and research efforts have been on digital baseband component separation and on digital and feedback calibration for gain and phase correction in LINC-based transmitting systems to apply LINC to recent wireless communication systems. Compared to the traditional mixer designs, the LINC transmitter has the following characteristics:
Significant improvement of power added efficiency
Two separated RF signals and two phase modulators
The separated signals have much wider spectral bandwidths
Additional calibration and compensation steps are required to maintain amplitude and phase balance on the two nonlinear signal paths

L. R. Kahn first proposed the envelope elimination and restoration (EE&R) technique in 1952. In an EE&R transmitter the RF signal is split into a phase modulated (PM) signal and an amplitude modulated (AM) signal. The PM signal is directly amplified by RF power amplifiers that operate in saturated or even switching mode, such as class-C, class-D, class-E, or class-F mode. In order to restore the amplitude, the supply voltage of the power amplifier is modulated by the AM signal. Thereby, although the power amplifier itself is operating in a nonlinear high-efficiency mode, the total transmitter shows linear behavior while maintaining the high efficiency. The characteristic of the natural split of AM and PM sometimes classifies the EE&R technique to the family of polar transmitter system.

FIG. 18 illustrates an example L-band EE&R transmitter that ensures high linearity by adding two features to the classical Kahn technique: two envelope-feedback loops and matched envelope detectors. The two feedback loops ensure high linearity in both the class-S modulator and modulation of the power amplifier. Matched envelope detectors operating at the same signal levels eliminate distortion caused by nonlinearities in the detectors.

Compared to the traditional upconversion techniques, EE&R has the following characteristics:
Improved power added efficiency by using nonlinear amplifier for RF amplification
Only phase signal need to be modulated to RF carriers as compared to LINC systems
The separated phase and amplitude signals have much wider spectrum bandwidth
The linearity of an EE&R transmitter does not depend upon the linearity of its RF-power transistors, but upon the accuracy of the reproduction of the input-signal's amplitude and phase information. The two principal factors that affect linearity are the bandwidth of the class-S modulator and the differential delay between the envelope and phase modulation at the final amplifier. Additional calibration and compensation are required to limit the distortion of these two factors.

Digital polar transmitter directly converts base band signal to polar format: phase and amplitude. The advanced digital technology ensures the accuracy of the amplitude and phase of any modulation schemes. FIG. 19 illustrates an example digital baseband EE&R transmitter, where the system is subdivided into two building blocks, i.e., the digital modulator and AM transmitter. In the digital modulator, the signal is split into a phase signal (RF-P) and amplitude (A) signal, which serve as the input signals of the AM transmitter for amplitude restoration.

A digital polar transmitter consists of RF analog phase modulation and amplification, and digital amplitude restoration. The RF signals are generated using a phase locked loop (PLL)-based phase modulator. The inphase/quadrature (I/Q) dependent amplitude is restored to the phase signal on the RF carrier through an amplitude restoration stage. The amplitude restoration stage splits the RF input signal to binary-scaled amplifier segments with quantized gain. The amplified signal is recombined at the output of the segments as shown in FIG. 20.

### SUMMARY

Disclosed is an apparatus and method for reducing peak-to-average power ratio (PAPR) in orthogonal frequency division multiplex (OFDM) signals.

According to one aspect, a method for reducing peak-to-average power ratio (PAPR) in orthogonal frequency division multiplex (OFDM), the method comprising using a Form OFDM Symbol component for forming a plurality of OFDM frequency domain subcarriers; mapping the plurality of OFDM frequency domain subcarriers into a plurality of subset subcarriers; converting the plurality of subset subcarriers into a plurality of time domain subwaveforms; recombining the plurality of time domain subwaveforms into two or more time domain combined signals with low Peak-to-Average Power Ratio (PAPR); and frequency upconverting the two or more time domain combined signals to obtain a transmit signal.

According to another aspect, a transmit device for reducing peak-to-average power ratio (PAPR) in orthogonal frequency division multiplex (OFDM), the transmit device comprising a Form OFDM Symbol component for forming a plurality of OFDM frequency domain subcarriers; an OFDM Symbol Partition component for mapping the plurality of OFDM frequency domain subcarriers into a plurality of subset subcarriers; a Subsection IFFT component for converting the plurality of subset subcarriers into a plurality of time domain subwaveforms; a Selective Optimal Combining component for recombining the plurality of time domain subwaveforms into two or more time domain combined signals with low Peak-to-Average Power Ratio (PAPR); and a Frequency Upconversion component for frequency upconverting the two or more time domain combined signals to obtain a transmit signal.

According to another aspect, an apparatus for reducing peak-to-average power ratio (PAPR) in orthogonal frequency division multiplex (OFDM), the apparatus comprising means for forming a plurality of OFDM frequency domain subcarriers; means for mapping the plurality of OFDM frequency domain subcarriers into a plurality of subset subcarriers; means for converting the plurality of subset subcarriers into a plurality of time domain subwaveforms; means for recombining the plurality of time domain subwaveforms into two or more time domain combined signals with low Peak-to-Average Power Ratio (PAPR); and means for frequency upconverting the two or more time domain combined signals to obtain a transmit signal.

According to another aspect, a computer-readable medium storing a computer program, wherein execution of the computer program is for forming a plurality of OFDM frequency domain subcarriers; mapping the plurality of OFDM frequency domain subcarriers into a plurality of subset subcarriers; converting the plurality of subset subcarriers into a plurality of time domain subwaveforms; recombining the plurality of time domain subwaveforms into two or more time domain combined signals with low Peak-to-Average Power Ratio (PAPR); and frequency upconverting the two or more time domain combined signals to obtain a transmit signal.

Advantages of the present disclosure include improving signal quality and transmission efficiency, reducing peak-to-average power ratio (PAPR) of the amplified transmit signals, and without adding complexity to the OFDMA receiver, maintaining the average transmit power level, maintaining computational efficiency while requiring no recursive iteration and no additional overhead bits for transmission, preserving original signal bandwidth allocation, and promoting low cost and high efficient RF hardware for OFDM based devices and equipments. Another advantage is the ability to apply the disclosed improvements in the peak-to-average power ratio (PAPR) to both base stations and mobile devices. One skilled in the art would understand that the listed advantages are not exclusive or comprehensive, and that in any one system, not all the advantages listed herein may be evident or present.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 illustrates an example multiple access wireless communication system in accordance with the present disclosure.

FIG. 2 illustrates an example block diagram of a transmitter system (a.k.a. access point) and a receiver system (a.k.a. access terminal) in a MIMO system.

FIG. 3 illustrates an example transmit device block diagram for orthogonal frequency division multiplex (OFDM) modulated signal transmission with reduced peak-to-average power ratio (PAPR).

FIG. 4 illustrates an example of a methods and algorithm diagram for minimizing the maximum Peak-to-Average Power Ratio (PAPR).

FIG. 5 illustrates an example of a Cartesian upconversion and amplification RF Analog front end component.

FIG. 6 illustrates an example simulation block diagram of a reduced Peak-to-Average Power Ratio (PAPR) OFDM transmitter in accordance with the present disclosure.

FIG. 7 illustrates an example flow diagram for reducing peak-to-average power ratio (PAPR) in orthogonal frequency division multiplex (OFDM).

FIG. 8 illustrates an example of a device comprising a processor in communication with a memory for executing the processes of reducing peak-to-average power ratio (PAPR) in orthogonal frequency division multiplex (OFDM).

FIG. 9 illustrates an example of a device suitable for reducing peak-to-average power ratio (PAPR) in orthogonal frequency division multiplex (OFDM).

FIG. 10 illustrates a prior art example of a companded multicarrier modulation (MCM) system with iterative receiver.

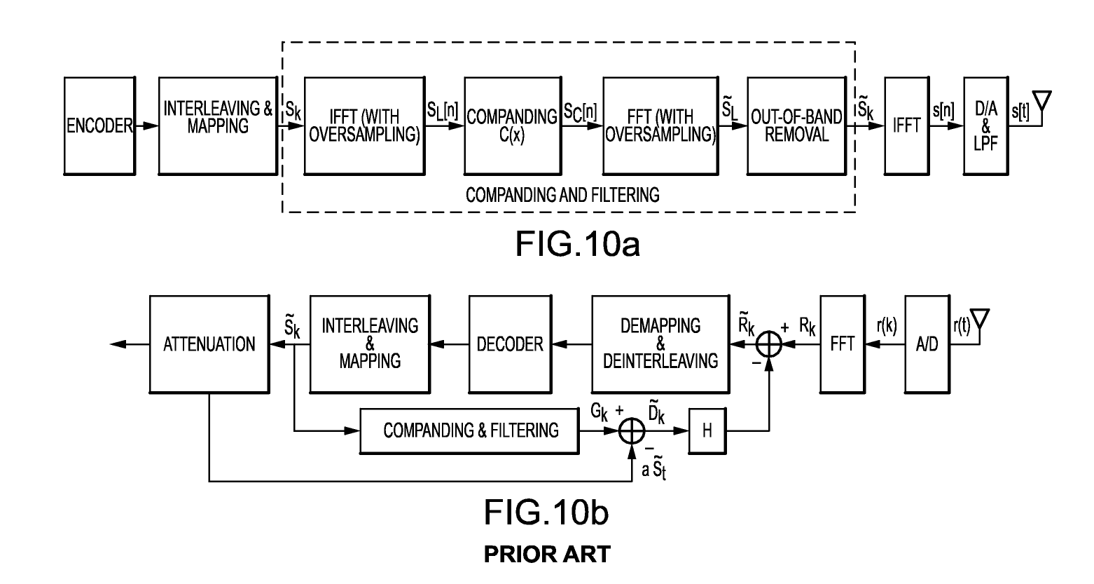

FIG. 11 illustrates a prior art example block diagram of the partial transmit sequence (PTS) technique.

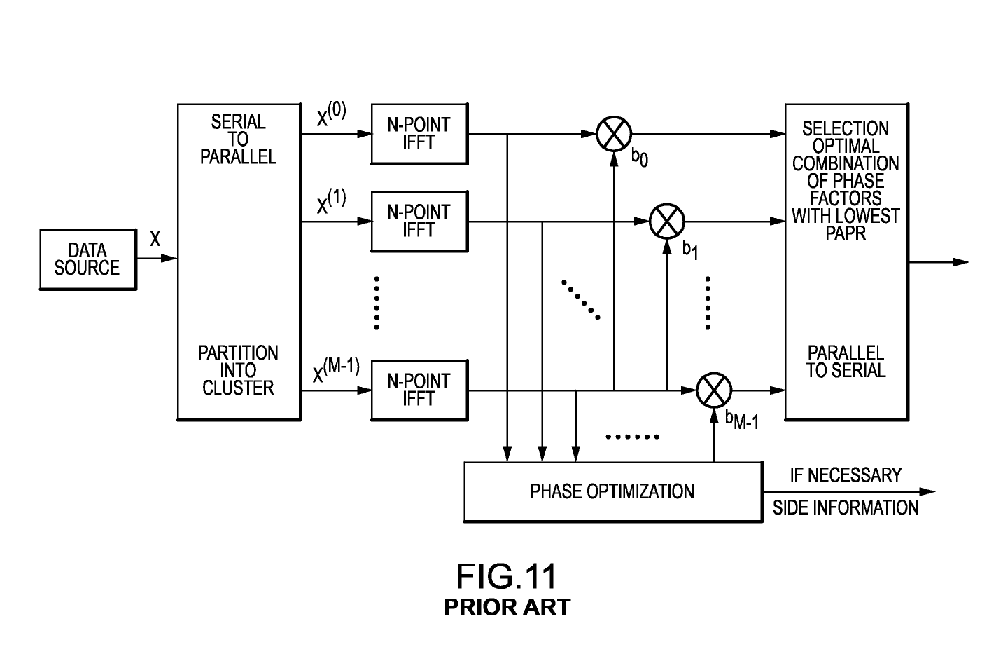

FIG. 12 illustrates a prior art example block diagram of the selective mapping (SLM) technique.

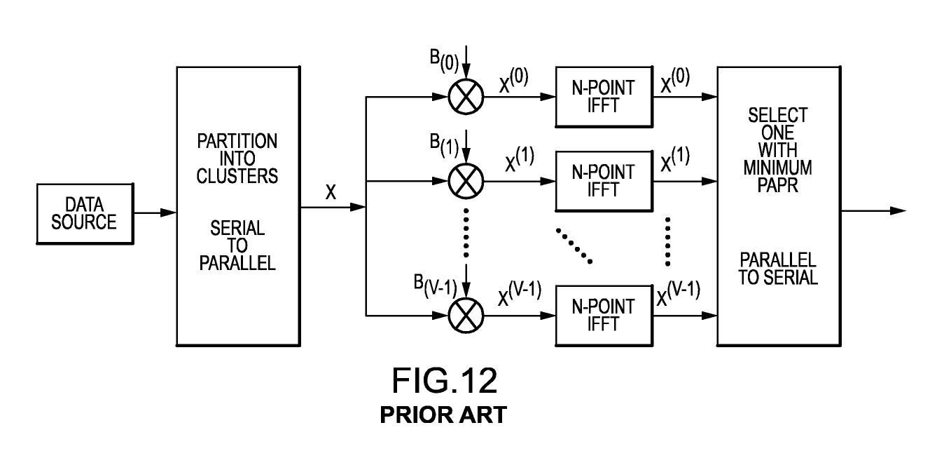

FIG. 13 illustrates a block diagram for implementing a waveform with sharp and unique peaks in counter phase to the largest peak(s) of each OFDM symbols in the prior art example technique of adding active subcarriers.

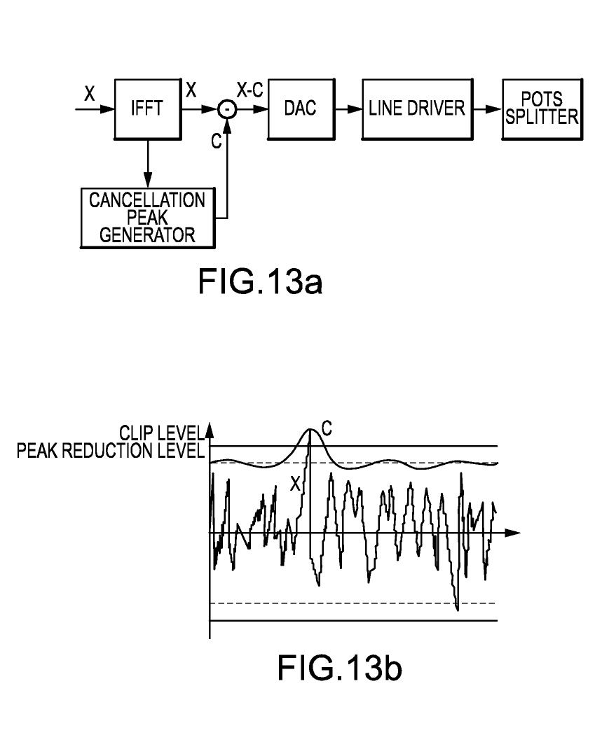

FIG. 14 illustrates a prior art example block diagram of pre-distortion linearizer with feedback amplification.

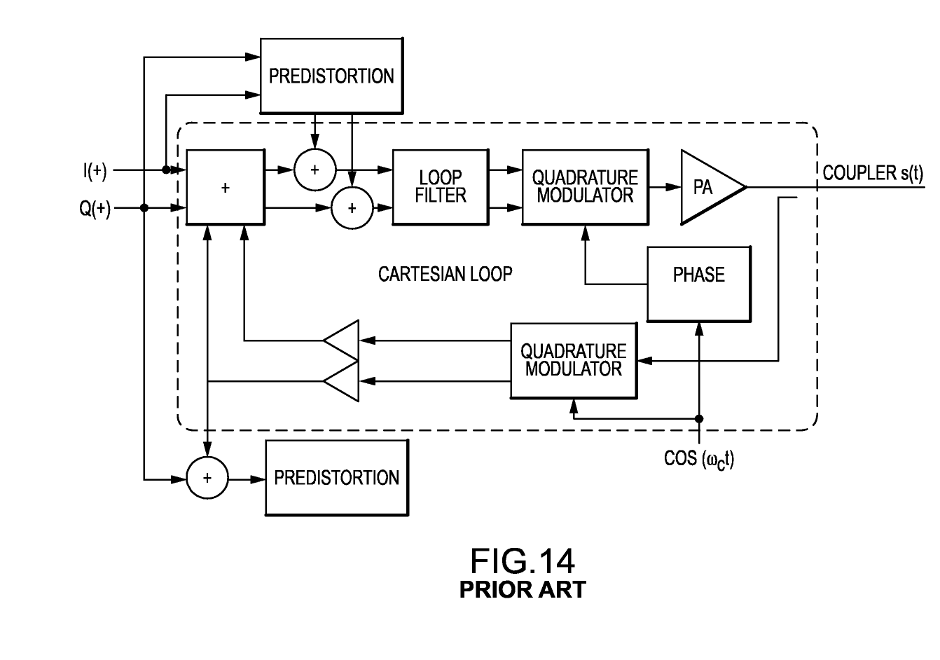

FIG. 15 illustrates a prior art example of a N-way Doherty amplifier.

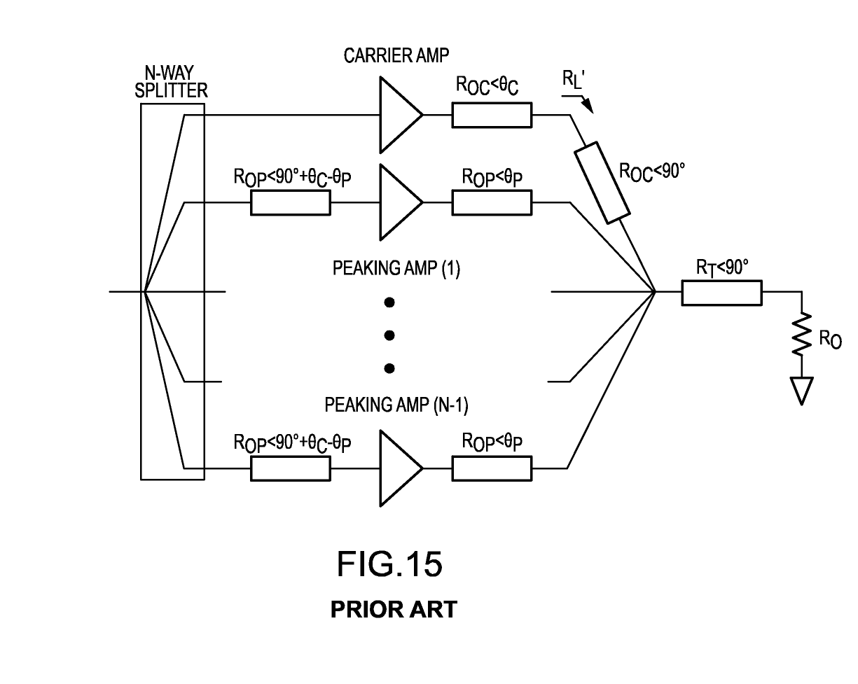

FIG. 16 illustrates a graph of efficiency versus output backoff for the N-way Doherty amplifier in FIG. 15.

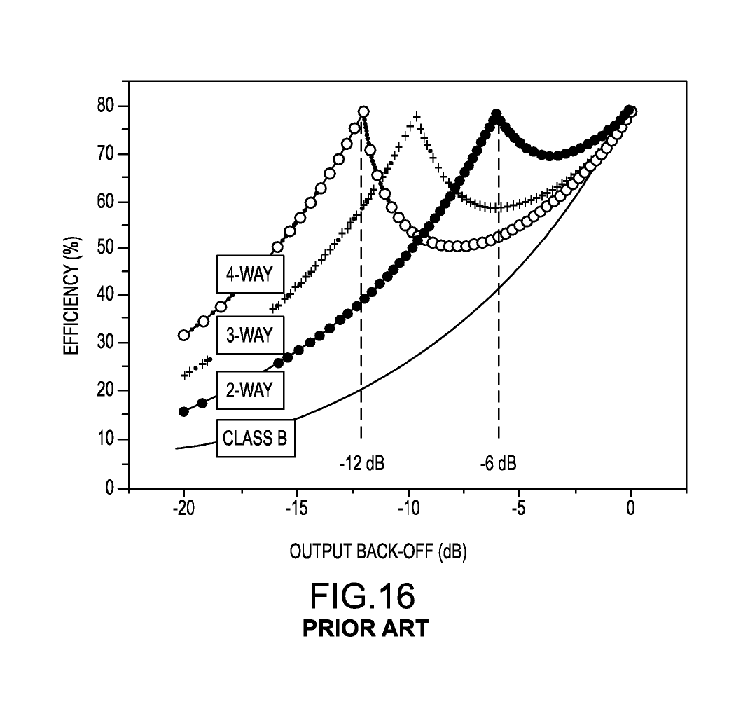

FIG. 17 illustrates a prior art example block diagram of a LINC amplifier.

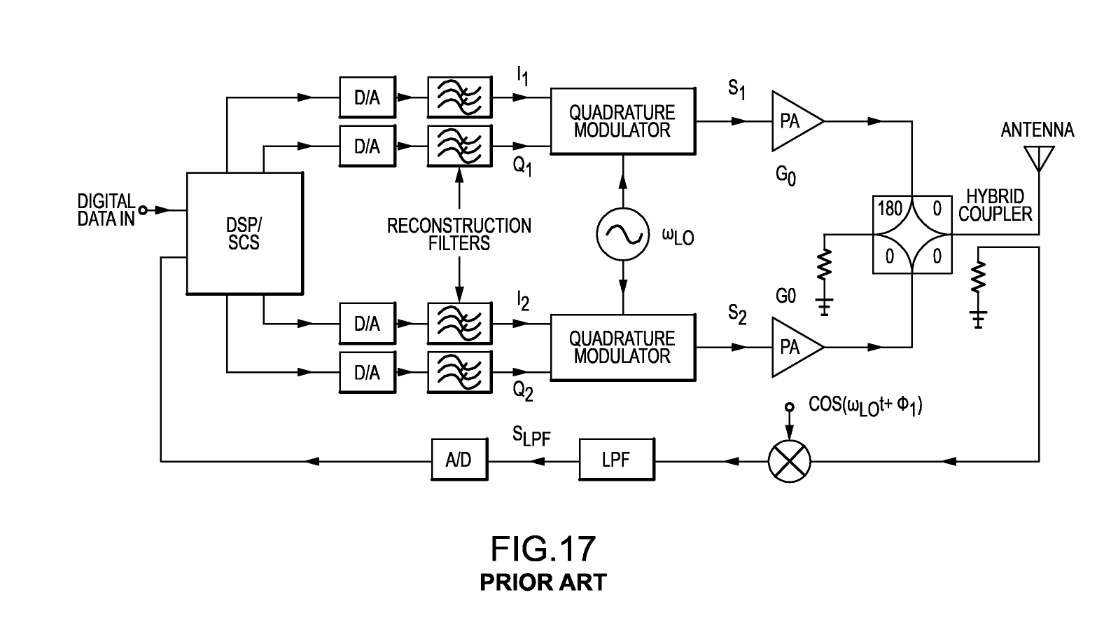

FIG. 18 illustrates a prior art example of a L-band envelope elimination and restoration (EE&R) transmitter.

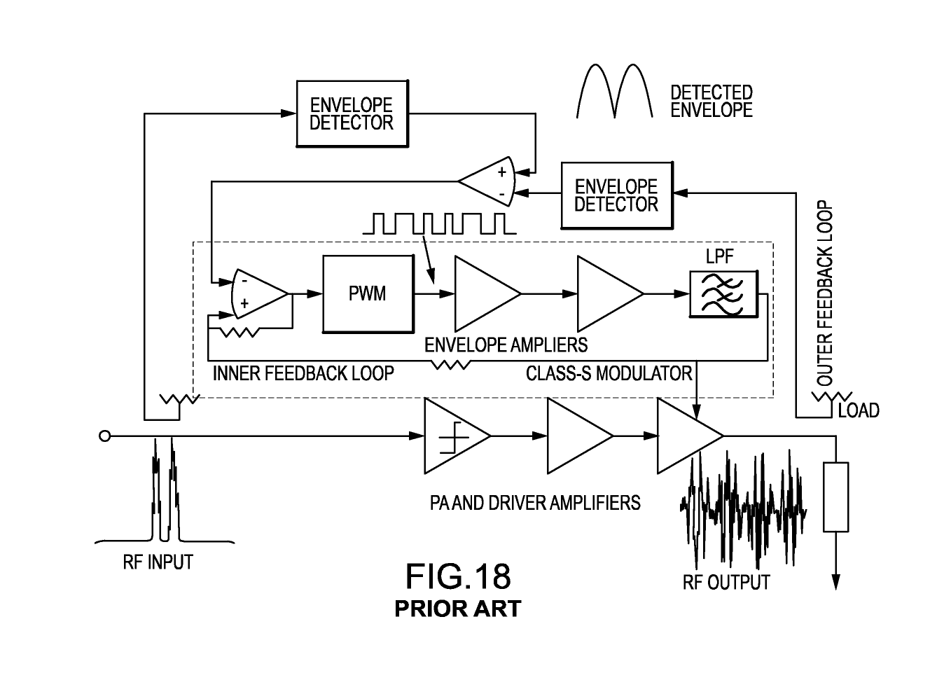

FIG. 19 illustrates a prior art example of a digital baseband envelope elimination and restoration (EE&R) transmitter.

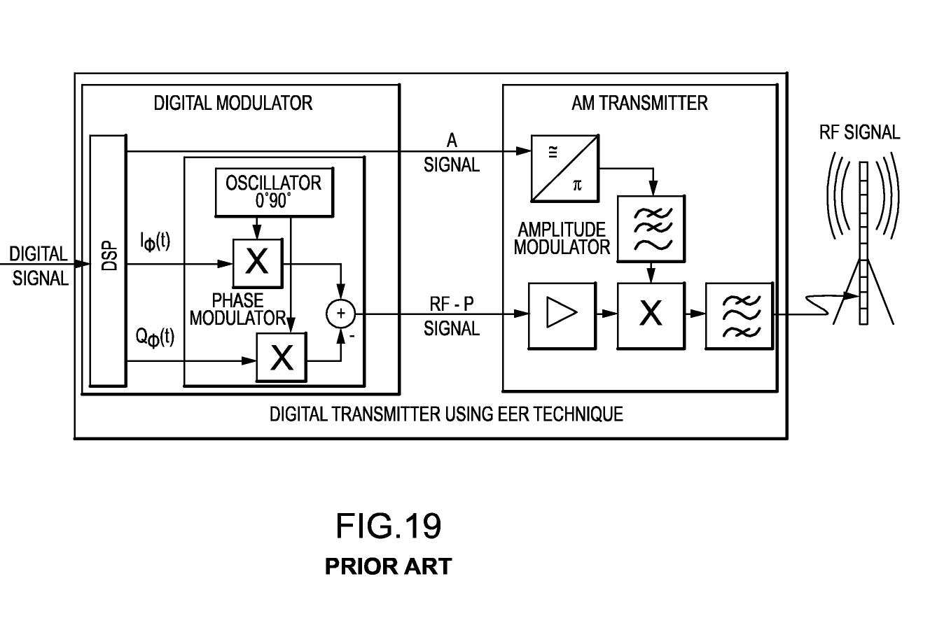

FIG. 20 illustrates a prior art example of a digital polar transmitter.

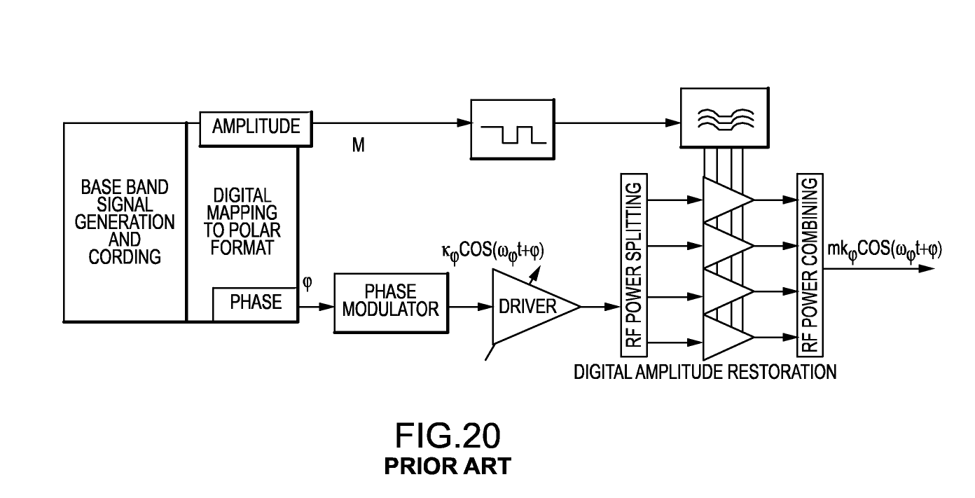

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the present disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). Cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is one multiple access technique. SC-FDMA has similar performance and essentially similar overall complexity as those of a OFDMA system. A SC-FDMA signal has a lower peak-to-average power ratio (PAPR) because of its inherent single carrier structure. SC-FDMA has drawn much attention, especially in the uplink communications where lower PAPR greatly benefits the mobile device (a.k.a. mobile terminal, user equipment (UE), access terminal, etc.) in terms of transmit power efficiency. In one example, SC-FDMA is an uplink multiple access scheme in 3GPP Long Term Evolution (LTE), or Evolved UTRA.

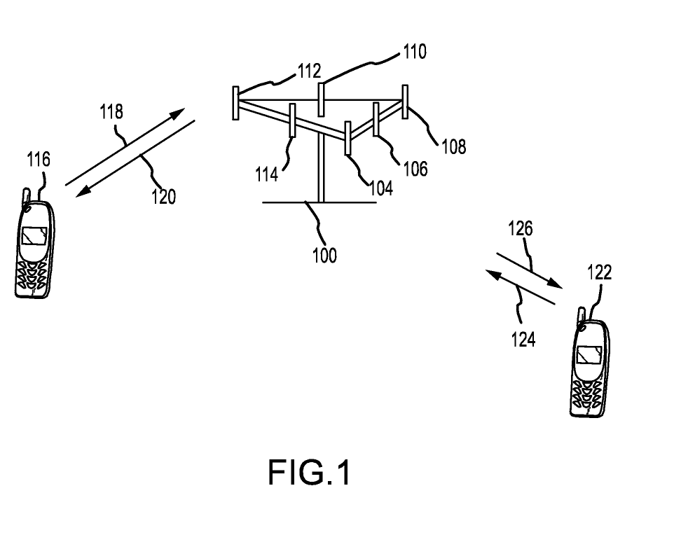

FIG. 1 illustrates an example multiple access wireless communication system in accordance with the present disclosure. An access point 100 (AP), also referred to as e-Node B or e-NB, includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT), also referred to as user equipment (UE), is in communication with antennas 112 and 114, where antennas 112 and 114 transmit information to access terminal 116 over forward link 120 and receive information from access terminal 116 over reverse link 118. Access terminal 122 is in communication with antennas 106 and 108, where antennas 106 and 108 transmit information to access terminal 122 over forward link 126 and receive information from access terminal 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access point. In the embodiment, antenna groups each are designed to communicate to access terminals in a sector, of the areas covered by access point 100.

In communication over forward links 120 and 126, the transmitting antennas of access point 100 utilize beamforming in order to improve the signal-to-noise ratio of forward links for the different access terminals 116 and 124. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as an access point, a Node B, or some other terminology. An access terminal may also be called an access terminal, user equipment (UE), a wireless communication device, terminal, access terminal or some other terminology.

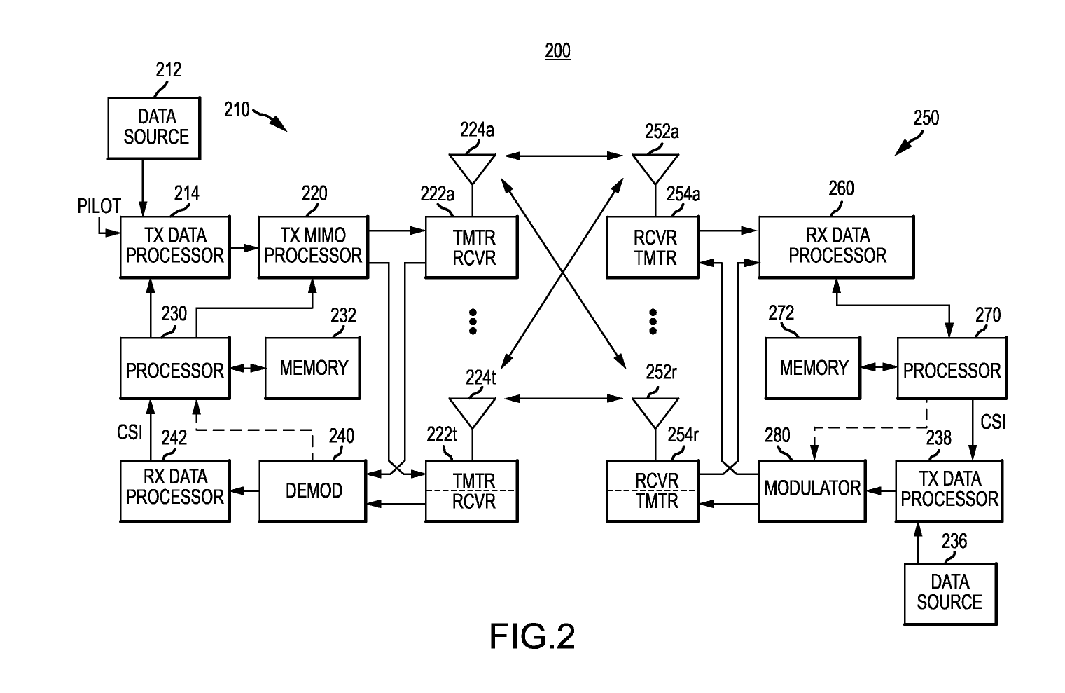

FIG. 2 illustrates an example block diagram of a transmitter system 210 (a.k.a. access point) and a receiver system 250 (a.k.a. access terminal) in a MIMO system 200. At the transmitter system 210, traffic data for a number of data streams is provided from a data source 212 to a transmit (TX) data processor 214.

In one example, each data stream is transmitted over a respective transmit antenna. TX data processor 214 formats, codes, and interleaves the traffic data for each data stream based on a particular coding scheme selected for that data stream to provide coded data. The coded data for each data stream is multiplexed with pilot data using, for example, OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., in OFDM). The TX MIMO processor 220 provides N_{T} modulation symbol streams to N_{T} transmitters (TMTR) 222a through 222t. In one aspect, the TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

A RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at the transmitter system 210. A processor 270 periodically determines which pre-coding matrix to use. Processor 270 formulates a reverse link message comprising a matrix index portion and a rank value portion. In one example, the reverse link message comprises various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At the transmitter system 210, the modulated signals from the receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights and processes the extracted message.

In an aspect, logical channels are classified into Logical Control Channels and Logical Traffic Channels. One example of a Logical Control Channel is a Broadcast Control Channel (BCCH) which is a downlink (DL) channel for broadcasting system control information. Another example of a Logical Control Channel is a Paging Control Channel (PCCH) which is downlink (DL) channel that transfers paging information. Another example of a Logical Control Channel is a Multicast Control Channel (MCCH) which is a point-to-multipoint downlink (DL) channel used for transmitting Multimedia Broadcast and Multicast Service (MBMS) scheduling and control information for one or several Multicast Traffic Channels (MTCHs). Generally, after establishing a radio resource control (RRC) connection this channel is only used by mobile devices (a.k.a. mobile terminals, user equipments (UEs), access terminals, etc.) that receive MBMS. Another example of a Logical Control Channel is a Dedicated Control Channel (DCCH) which is a point-to-point bi-directional channel that transmits dedicated control information and is used by mobile devices having RRC connections.

One example of a Logical Traffic Channel is a Dedicated Traffic Channel (DTCH) which is a point-to-point bi-directional channel, dedicated to one mobile device, for the transfer of user information. Another example of a Logical Traffic Channel is a Multicast Traffic Channel (MTCH) which is a point-to-multipoint downlink (DL) channel for transmitting traffic data.

In an aspect, Transport Channels are classified into downlink (DL) and uplink (UL) channels. Examples of DL Transport Channels include a Broadcast Channel (BCH), a Downlink Shared Data Channel (DL-SDCH) and a Paging Channel (PCH). The PCH is used for support of mobile device power saving. The Discontinuous Reception (DRX) cycle for the mobile device power saving is indicated by the network to the mobile device. The PCH is broadcasted over entire the cell and mapped to physical layer (PHY) resources which can be used for other control or traffic channels.

Examples of UL Transport Channels include a Random Access Channel (RACH), a Request Channel (REQCH), a Uplink Shared Data Channel (UL-SDCH) and a plurality of physical layer (PHY) channels. The physical layer (PHY) channels include a set of downlink (DL) channels and uplink (UL) channels.

In one aspect, the downlink (DL) physical layer (PHY) channels include one of more of the following:
Common Pilot Channel (CPICH)
Synchronization Channel (SCH)
Common Control Channel (CCCH)
Shared DL Control Channel (SDCCH)
Multicast Control Channel (MCCH)
Shared UL Assignment Channel (SUACH)
Acknowledgement Channel (ACKCH)
DL Physical Shared Data Channel (DL-PSDCH)
UL Power Control Channel (UPCCH)
Paging Indicator Channel (PICH)
Load Indicator Channel (LICH)

In one aspect, the uplink (UL) physical layer (PHY) channels include one of more of the following:
Physical Random Access Channel (PRACH)
Channel Quality Indicator Channel (CQICH)
Acknowledgement Channel (ACKCH)
Antenna Subset Indicator Channel (ASICH)
Shared Request Channel (SREQCH)
UL Physical Shared Data Channel (UL-PSDCH)
Broadband Pilot Channel (BPICH)

In one aspect, a channel structure is provided that preserves low PAPR (at any given time, the channel is contiguous or uniformly spaced in frequency) properties of a single carrier waveform. Orthogonal frequency division multiplexing (OFDM) is used in wideband high data rate wireless communication systems such as 3GPP Long Term Evolution (LTE) systems, 3GPP2 Ultra Mobile Broadband (UMB) systems, wireless microwave access (WiMAX) systems. OFDM offers a) high spectrum efficiency, b) multipath delay spread tolerance, and c) immunity to frequency selective fading in digital broadcast applications.

However, as stated above, one problem that restricts OFDM usage in some applications is its inherent high peak-to-average power ratio (PAPR). Since OFDM is a multicarrier transmission technique, any transmission nonlinearity in the transmitter or receiver may result in degraded performance. The nonlinearity interaction between multiple carriers causes unwanted byproducts, such as intermodulation products, and power robbing.

In one aspect, the higher the number of subcarriers, the higher the peak-to-average power ratio (PAPR). High PAPR may cause significant degradation of the received signal due to the nonlinearity of the transmitter and receiver and may dramatically reduce power efficiency. Particularly affected are the high power amplifiers in the transmitters. One technique to minimize nonlinearity degradation is called amplifier back off. In amplifier back off, the input drive level to a nonlinear amplifier is lowered (i.e., the back off is increased) to maintain a more linear input-output characteristic. However, a larger amplifier back off, that is, a lower input drive level, has the disadvantage of also lowering the desired signal-to-thermal noise ratio (SNR). Thus, a compromise is needed in the amplifier back off level to balance the nonlinearity degradations with the signal-to-thermal noise ratio (SNR) considerations.

Using a waveform transmission technique which mitigates amplifier nonlinearity degradation and allows a reduced back off operating point is preferred. Thus, there is a need for low PAPR transmitters for OFDM transmit subsystems to mitigate the problems caused by transmission nonlinearity.

The present disclosure discloses a transmission apparatus and method for transmitting OFDM modulated signals while requiring less stringent back off on the power amplifier and thus reducing peak-to-average power ratio (PAPR) input signals. That is, the present disclosure seeks to improve peak-to-average power ratio (PAPR) in orthogonal frequency division multiplex (OFDM) systems.

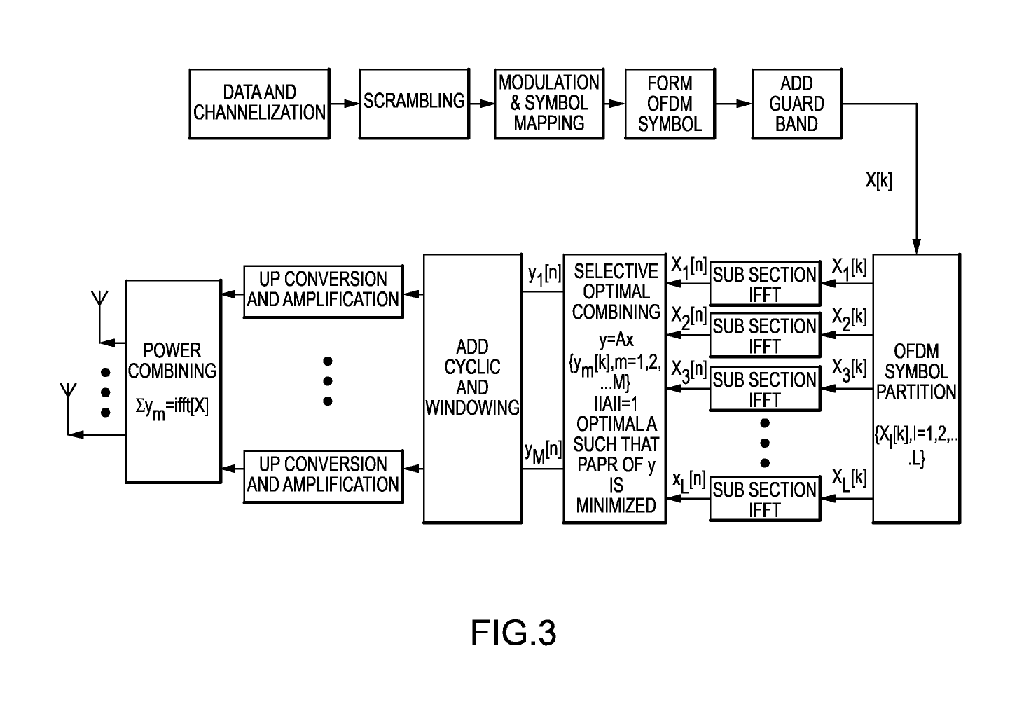

FIG. 3 illustrates an example transmit device block diagram for OFDM modulated signal transmission with reduced peak-to-average power ratio (PAPR). As illustrated in FIG. 3, the full OFDM subcarriers, denoted as vector X, are mapped into L subsets of subcarriers, denoted as vector X₁, for 1=1, 2, . . . L. The subset X₁ are converted into time domain subwaveforms through a sub-block IFFT {x₁=IFFT(X₁), 1=1, 2, . . . L}. Then the time domain subwaveforms are selectively recombined into two or more time domain combined signals with low PAPR by a selective optimal mapping operator A. The PAPR reduced signals {yₘ[n], m=1,2, . . . M} are then frequency upconverted and amplified in parallel. The amplified signals are then combined to an antenna or multi-antenna for an MIMO system.

In one aspect, a digital signal is sent to the RF front end hardware using an optimal selecting and mapping approach. Parallel RF front end hardware frequency upconverts and amplifies the transmit signals. The transmit signals are then combined and transmitted into free space. Four issues are addressed by this approach. The first is eliminating additional transmission overhead bits. The second is simplifying transmission and reception complexity. The third is promoting low cost and simple RF/analog front end hardware. And, the fourth is reducing the signal peak-to-average power ratio (PAPR).

In one example, computer simulation results show that the peak-to-average power ratio (PAPR) of the transmit subsystem can be dramatically improved. And, there is also improvement of the transmit signal quality, such as modulation error ratio (MER), adjacent channel emission spectrum, and signal constellation while using limited power amplifier output back off (OBO).

In one aspect, the present disclosure discloses a reduced PAPR OFDM signal transmission solution that uses both digital baseband signal optimization and analog RF hardware to achieve high signal quality and transmission efficiency with reduced transmission complexity and cost. In one example, a digital signal is provided to the OFDM RF front end using an optimal selecting and mapping approach. Parallel RF front end hardware frequency upconverts and amplifies the RF signals. Subsequently, the upconverted amplified RF signals are combined and transmitted into free space. The PAPR of baseband signals is reduced and there is a less stringent back off requirement on the power amplifiers.

After channelization, mapping, scrambling, and adding guard band, the OFDM symbols are denoted as a vector X={X(1), X(2) . . . ,X(N)}^{T} where N is the number of subcarriers. And the signal to be transmitted in the time domain before addition of a cyclic prefix is the output of the Inverse Fast Fourier Transform (IFFT) of X:

$$x ( n ) = \frac{1}{N} {\sum }_{k = 0}^{N - 1} X ( k ) {e}^{\frac{j 2 π nk}{N}}$$

Denote the time domain transmit signal as vector x={x(n), n=0, 1, . . . , N-1}=IFFT(X). If the time domain transmit signal is processed with an over-sampling rate S, the PAPR is defined as:

$$PAPR ( x ) = \frac{max \{ {\vert x ( n ) \vert}^{2 ,} , for n = 0 , 1 , … , SN - 1 \}}{E {‖ x ‖}^{2}}$$

In one aspect, a higher PAPR requires a higher linearity of the RF hardware used for frequency upconversion and amplification. In one aspect, the OFDM transmission transmits the time domain transmit signal x through the transmit RF hardware with low PAPR to reduce the RF hardware requirements and to achieve higher power added efficiency.

First the full OFDM frequency domain subcarrier vector X are mapped into subset subcarrier vectors, {X₁, 1=1, 2, . . . L}, such that:

$$x = {\sum }_{l = 1}^{L} {x}_{1}$$

Next, the subset subcarriers are converted into time domain subwaveforms through sub-block IFFT: s={X₁=IFFT(X₁), 1=1, 2, . . . L}.

L is the number of sub-blocks of the IFFT, M is the number of transmit signals to be frequency upconverted and amplified. And y=AᵢS, for y={yₘ, m=1,2, . . . M}^{T}. The operators A_{i,} for i=1, . . . , I are M×L matrix and are selected such that:

$$x = {\sum }_{m = 1}^{M} {y}_{m}$$

Then, the time domain subwaveforms are selectively optimally recombined into two or more time domain combined signals with low Peak-to-Average Power Ratio (PAPR) by a selective optimal mapping operator

A*ε A [symbol] {A_{i,} M×L, for i=1, . . . , I},

and the optimal signal array for transmission is y*=A*S such that the corresponding PAPR is minimized:

$${A}^{*} = arg \{ {}_{{A}^{*} ∈ A}^{min} PAPR ( {y}_{m} ) , m = 1 , 2 , … , M \}$$

$$where$$

$$PAPR ( {y}_{m} ) = \frac{max \{ {\vert {y}_{m} ( n ) \vert}^{2} n = 0 , 1 , … , N \}}{E {‖ {y}_{m} ‖}^{2}}$$

In one aspect, the selective optimal mapping mitigates the transmit nonlinear distortion that causes undesired high Peak-to-Average Power Ratio (PAPR). The signals y*ₘ, m=1,2, . . . M are frequency upconverted and amplified. The amplified transmit signals are then combined to an antenna or to multi-antennas in a MIMO system. That is, with the optimal mapping from x to y, the Peak-to-Average Power Ratio (PAPR) of y is minimized.

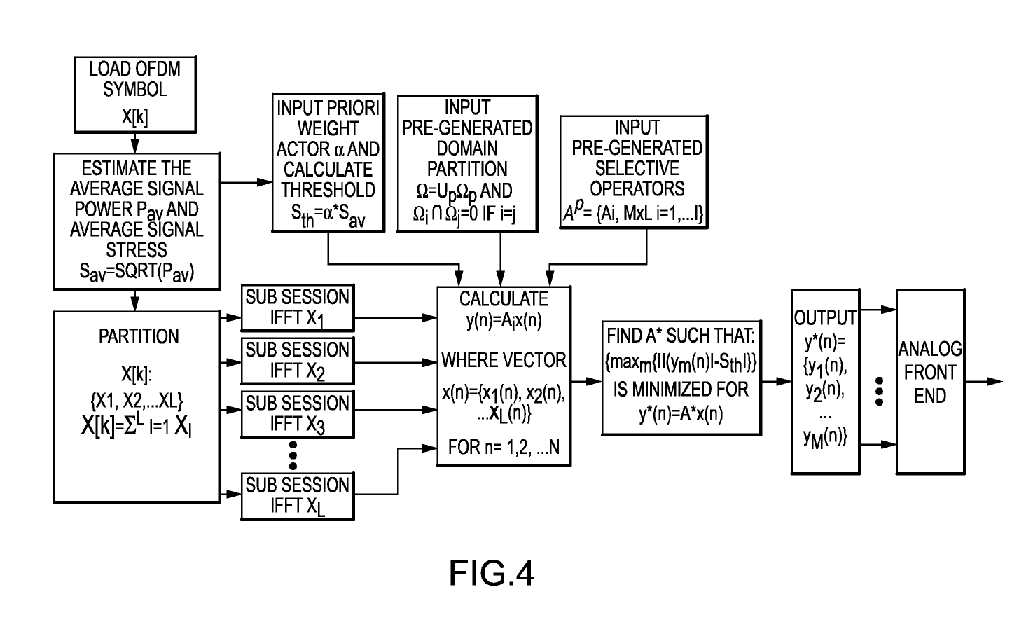

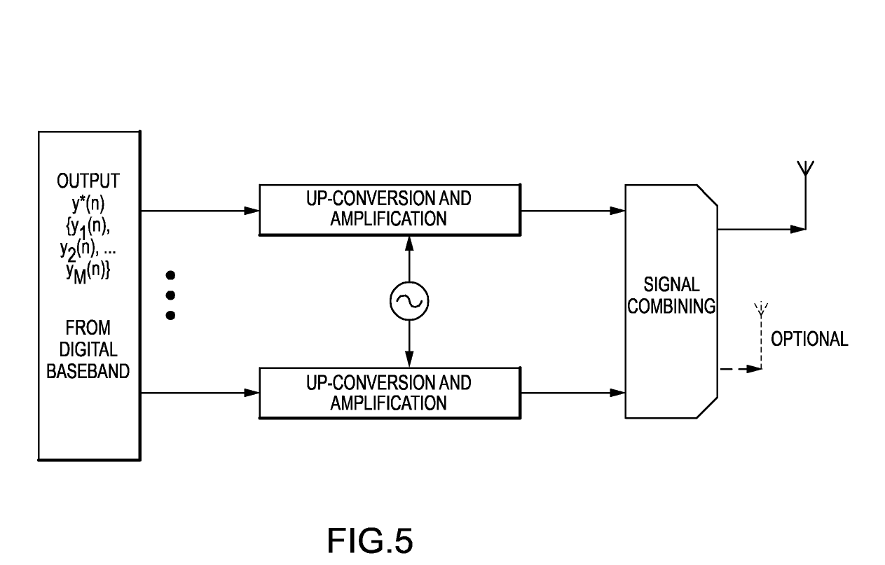

In one aspect, the selective optimal mapping and recombining steps includes some flexibilities to enhance the advantage of a RF front end hardware. FIG. 4 illustrates an example of a Cartesian type RF front end hardware for minimizing the maximum Peak-to-Average Power Ratio (PAPR). In one example, for the Cartesian type of RF frequency upconversion and amplification, the mapping algorithm can be highlighted as shown in FIG. 4. And, correspondingly, FIG. 5 illustrates an example of a Cartesian upconversion and amplification RF Analog front end component.

In one example, to further increase the selective optimal mapping efficiency, the amplitude and/or phase domain Ω is partitioned into p sub-domains, where Ω={Ω₁, Ω₂, . . . , Ωₚ, for Ωᵢ ∩ Ωⱼ= [symbol] , if i≠j, and Ω=U Ωⱼ}. In each Ωₚ, the local candidates of selective operators is defined as £={Aᵢ^{p}, M×L, for I=1 . . . I}. In this way, the optimal search time is reduced.

In one aspect, the present disclosure of reduced PAPR OFDM signal transmission uses both digital signaling optimization and analog RF hardware to achieve signal quality and transmission efficiency. The reduced PAPR OFDM signal transmission includes one or more of the following advantages:
significantly reduces the PAPR of signals for amplification through the optimal partition and recombination and diminishes the inherent in-phase superposition of the Fast Fourier Transform (FFT) process in OFDM
promotes low cost and high efficiency RF hardware for OFDM based devices through the selective composition of the signals to be amplified
each component of y is constructed to leverage the RF front end performance with reduced input signal stringency, such as PAPR, phase and/or amplitude spectrum
the final transmitted signals are the original baseband signals and no additional bits need be transmitted; therefore it does not require additional overhead bits transmission compared to some other digital signaling PAPR reduction techniques.
does not add any complexity to OFDM receivers
does not increases average transmission power and original signal bandwidth
does not require recursive iteration and is computationally efficient
applicable to both the base stations and mobile devices

In one example, an OFDM symbol is partitioned into 4 sub-blocks:

X=X₁+X₂X₃+X₄

wherein:

$${X}_{1} ( k ) = \{ X ( k ) , k = 0 , 1 , - \frac{N}{4} - 1 \} , \\ {X}_{2} ( k ) = \{ X ( k ) , k = \frac{N}{4} , \frac{N}{4} + 1 , … \frac{N}{2} - 1 \}$$

$${X}_{2} ( k ) = \{ X ( k ) , k = \frac{N}{2} , \frac{N}{2} + 1 , … \frac{3 N}{4} - 1 \} , \\ {X}_{4} ( k ) = \{ X ( k ) , k = \frac{3 N}{4} , \frac{3 N}{4} + 1 , … N - 1 \}$$

The 4 sub-blocks are optimally selected and compressed into two time domain signals that are frequency upconverted and transmitted. The selective optimal mapping operator set A is composed of three candidates defined as:

$$A {=}^{Δ} \{ [ \begin{matrix}1 & 0 & 1 & 0 \\ 0 & 1 & 0 & 1\end{matrix} ] , [ \begin{matrix}1 & 1 & 0 & 0 \\ 0 & 0 & 1 & 1\end{matrix} ] , [ \begin{matrix}1 & 0 & 0 & 1 \\ 0 & 1 & 1 & 0\end{matrix} ] \} .$$

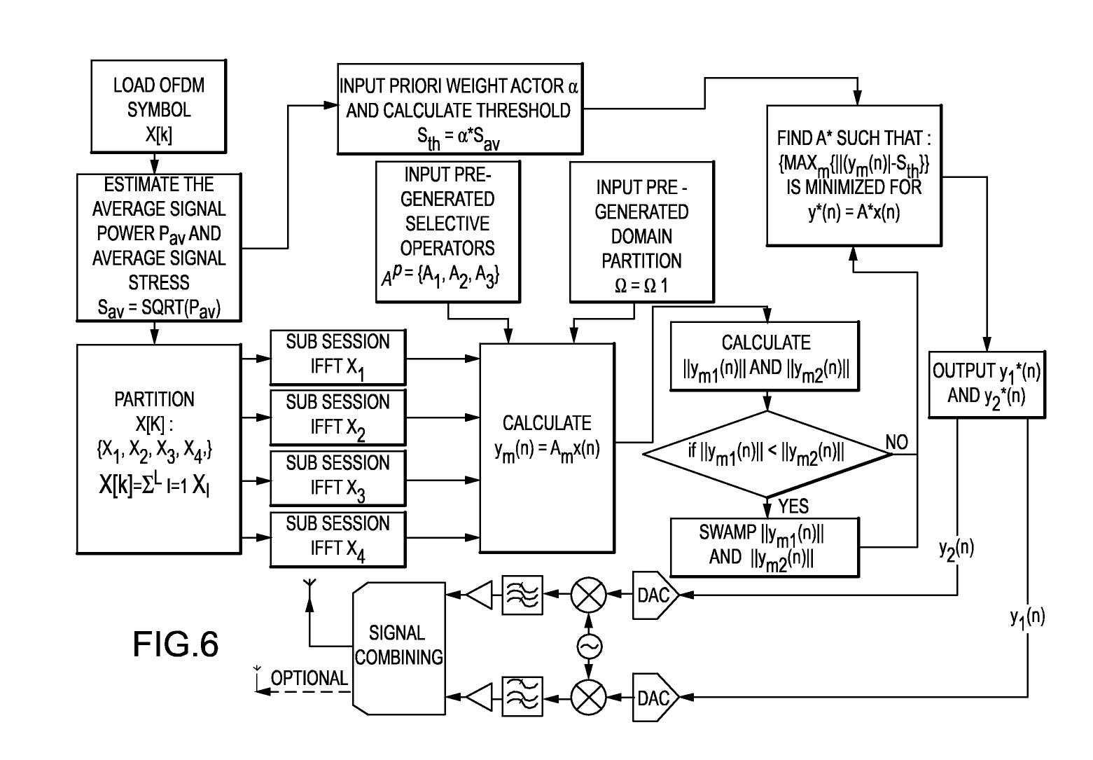

FIG. 6 illustrates an example simulation block diagram of a reduced Peak-to-Average Power Ratio (PAPR) OFDM transmitter in accordance with the present disclosure. In one example where the spectrum of an OFDM transmit system included a 7 dB output back off from the original signal, an OFDM size of 4096, a modulation type of 64 QAM (quadrature amplitude modulation), more than 3 dB PAPR reduction is achieved. The MER is improved by more than 6 dB and a constellation margin of 2× is achieved. And, in another example where the spectrum of an OFDM transmit system included a 5 dB output back off from the original signal, an OFDM size of 4096, a modulation type of 16 QAM (quadrature amplitude modulation), more than 3 dB PAPR reduction is achieved. The MER is improved by more than 7 dB and a constellation margin of 3× is achieved.

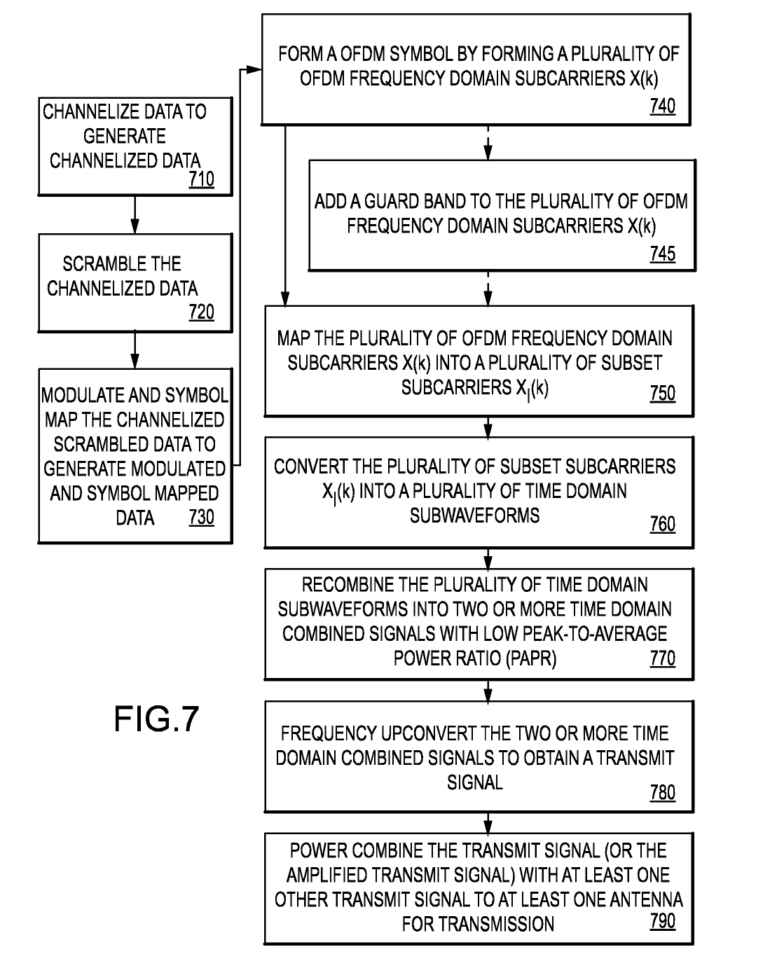

FIG. 7 illustrates an example flow diagram for reducing peak-to-average power ratio (PAPR) in orthogonal frequency division multiplex (OFDM). In block 710, channelize data to generate channelized data. Following block 720, scramble the channelized data, and in block 730, modulate and symbol map the channelized scrambled data to generate modulated and symbol mapped data.

In Block 740, form a OFDM symbol by forming a plurality of OFDM frequency domain subcarriers X(k). In one example, the step of Block 740 is performed by the Form OFDM Symbol component shown in FIG. 3. In one aspect, modulated and symbol mapped data are used in forming the OFDM symbol. In one example, the plurality of OFDM frequency domain subcarriers includes at least one pilot signal. In another example, the plurality of OFDM frequency domain subcarriers are all pilot signals. Here, in one example, all the pilot signals are equally distributed among the transmit antennas of a MIMO communication system.

In Block 745, add a guard band to the plurality of OFDM frequency domain subcarriers X(k). In one example, the step of Block 745 is performed by the Add Guard Band component shown in FIG. 3. In one example, the step in Block 745 is an optional step.

Following either Blocks 740 or Block 745, in Block 750, map the plurality of OFDM frequency domain subcarriers X(k) into a plurality of subset subcarriers X₁(k). In one example, the step of Block 750 is performed by the OFDM Symbol Partition component shown in FIG. 3. In one aspect, the plurality of OFDM frequency domain subcarriers includes at least one pilot signal which is confined to one of the subset subcarriers. And, in one example, the subset subcarrier is equally distributed among at least two transmit antennas of a MIMO communication system.

Following Block 750, in Block 760, convert the plurality of subset subcarriers X₁(k) into a plurality of time domain subwaveforms. In one aspect, Inverse Fast Fourier Transform (IFFT) is used for the conversion. And, the step of Block 760 is performed by the Subsection IFFT component shown in FIG. 3.

Following Block 760, in Block 770, recombine the plurality of time domain subwaveforms into two or more time domain combined signals with low Peak-to-Average Power Ratio (PAPR). In one example, the step of Block 770 is performed by the Selective Optimal Combining component shown in FIG. 3. In one aspect, a selective optimal mapping operator A* is used for the recombining process. In one example, the selective optimal mapping operator A* is defined as:

A*ε A [symbol] {A_{i,}M×L, for i=1, . . . , I},

Following Block 770, in Block 780, frequency upconvert the two or more time domain combined signals to obtain a transmit signal. In one example, the step of Block 780 is performed by the Upconversion component shown in FIG. 3. In one example, the two or more time domain combined signals are also amplified such that the transmit signal is an amplified transmit signal. The amplification can be performed by the Amplification component shown in FIG. 3.

Following Block 780, in Block 790, power combine the transmit signal (or the amplified transmit signal) with at least one other transmit signal for transmission on at least one antenna. In one example, the step of Block 790 is performed by the Power Combining component shown in FIG. 3.

In one example, the steps in Blocks 710 through Block 790 are executed in a multiple-input-multiple-output (MIMO) communication system. In another example, the multiple-input-multiple-output (MIMO) communication system further performs channel estimation using the power combined transmit signals. In one aspect, the plurality of subset subcarriers is partitioned into at least two processing paths to at least two transmit antennas of the MIMO communication system. In this aspect, the processing paths include the converting, recombining and frequency upconverting steps in Blocks 760, 770 and 780, respectively.

One skilled in the art would understand that the steps disclosed in the example flow diagram in FIG. 7 can be interchanged in their order without departing from the scope and spirit of the present disclosure. Also, one skilled in the art would understand that the steps illustrated in the flow diagram are not exclusive and other steps may be included or one or more of the steps in the example flow diagram may be deleted without affecting the scope and spirit of the present disclosure.

Those of skill would further appreciate that the various illustrative components, logical blocks, modules, circuits, and/or algorithm steps described in connection with the examples disclosed herein may be implemented as electronic hardware, firmware, computer software, or combinations thereof. To clearly illustrate this interchangeability of hardware, firmware and software, various illustrative components, blocks, modules, circuits, and/or algorithm steps have been described above generally in terms of their functionality. Whether such functionality is implemented as hardware, firmware or software depends upon the particular application and design constraints imposed on the overall system. Skilled artisans may implement the described functionality in varying ways for each particular application, but such implementation decisions should not be interpreted as causing a departure from the scope or spirit of the present disclosure.

For example, for a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described therein, or a combination thereof. With software, the implementation may be through modules (e.g., procedures, functions, etc.) that perform the functions described therein. The software codes may be stored in memory units and executed by a processor unit. Additionally, the various illustrative flow diagrams, logical blocks, modules and/or algorithm steps described herein may also be coded as computer-readable instructions carried on any computer-readable medium known in the art or implemented in any computer program product known in the art.

In one or more examples, the steps or functions described herein may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

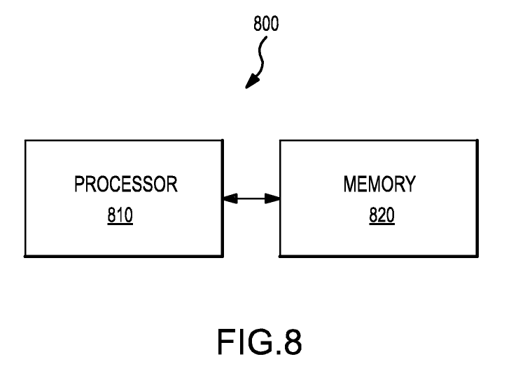

In one example, the illustrative components, flow diagrams, logical blocks, modules and/or algorithm steps described herein are implemented or performed with one or more processors. In one aspect, a processor is coupled with a memory which stores data, metadata, program instructions, etc. to be executed by the processor for implementing or performing the various flow diagrams, logical blocks and/or modules described herein. FIG. 8 illustrates an example of a device 800 comprising a processor 810 in communication with a memory 820 for executing the processes of reducing peak-to-average power ratio (PAPR) in orthogonal frequency division multiplex (OFDM). In one example, the device 800 is used to implement the algorithm illustrated in FIG. 7. In one aspect, the memory 820 is located within the processor 810. In another aspect, the memory 820 is external to the processor 810. In one aspect, the processor includes circuitry for implementing or performing the various flow diagrams, logical blocks and/or modules described herein.

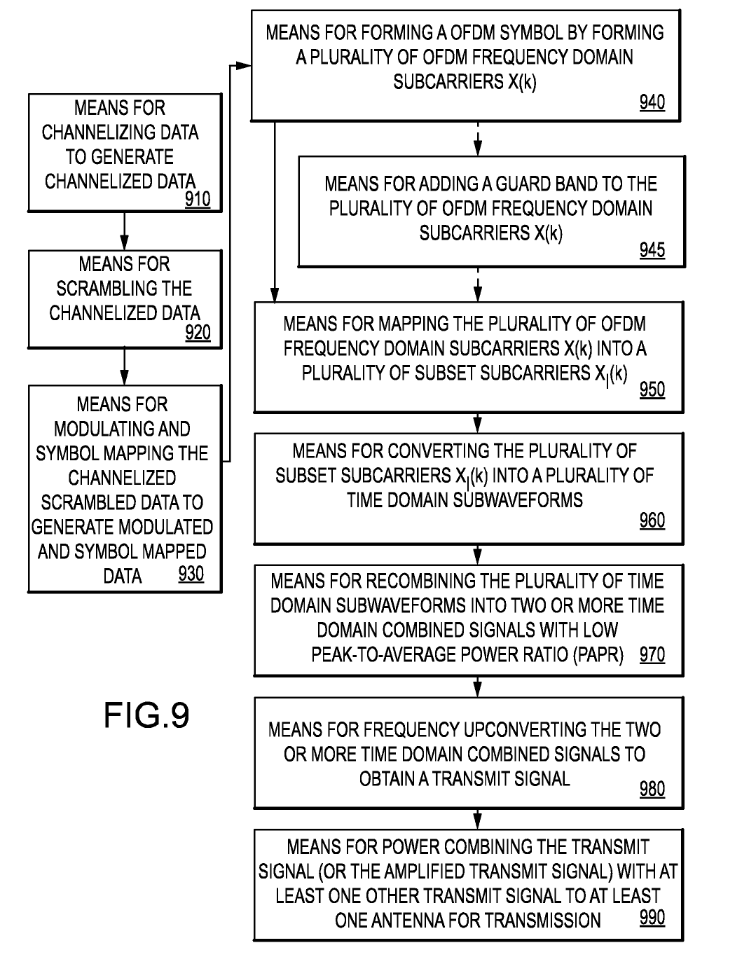

FIG. 9 illustrates an example of a device 900 suitable for reducing peak-to-average power ratio (PAPR) in orthogonal frequency division multiplex (OFDM). In one aspect, the device 900 is implemented by at least one processor comprising one or more modules configured to provide different aspects of reducing peak-to-average power ratio (PAPR) in an orthogonal frequency division multiplex (OFDM) system as described herein in blocks 910, 920, 930, 940, 945, 950, 960, 970, 980 and 990. For example, each module comprises hardware, firmware, software, or any combination thereof. In one aspect, the device 900 is also implemented by at least one memory in communication with the at least one processor.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A method for reducing peak-to-average power ratio (PAPR) in orthogonal frequency division multiplex (OFDM), the method comprising:
using a Form OFDM Symbol component for forming a plurality of OFDM frequency domain subcarriers;
mapping the plurality of OFDM frequency domain subcarriers into a plurality of subset subcarriers;
converting the plurality of subset subcarriers into a plurality of time domain subwaveforms;
recombining the plurality of time domain subwaveforms into two or more time domain combined signals with low Peak-to-Average Power Ratio (PAPR); and
frequency upconverting the two or more time domain combined signals to obtain a transmit signal.

2. The method of claim 1 further comprising power combining the transmit signal with at least one other transmit signal for transmission on at least one antenna.

3. The method of claim 2 wherein the at least one antenna is part of a multiple-input-multiple-output (MIMO) communication system.

4. The method of claim 3 wherein the MIMO communication system further performs channel estimation using the power combined transmit signals.

5. The method of claim 1 wherein the plurality of subset subcarriers is partitioned into at least two processing paths to at least two transmit antennas in a MIMO or antenna array communication system, and wherein the at least two processing paths include the converting, recombining and frequency upconverting steps of claim 1.

6. The method of claim 5 wherein the plurality of OFDM frequency domain subcarriers includes at least one pilot signal and the at least one pilot signal is confined to one of the plurality of subset subcarriers.

7. The method of claim 6 wherein the one of the plurality of subset subcarriers is equally distributed among the at least two transmit antennas in the MIMO or antenna array communication system.

8. The method of claim 1 wherein the plurality of OFDM frequency domain subcarriers includes at least one pilot signal.

9. The method of claim 1 wherein the plurality of OFDM frequency domain subcarriers are all pilot signals.

10. The method of claim 9 wherein the all pilot signals are equally distributed among a plurality of transmit antennas in a MIMO or antenna array communication system.

11. The method of claim 1 further comprising amplifying the two or more time domain combined signals to transform the transmit signal to an amplified transmit signal.

12. The method of claim 11 further comprising power combining the amplified transmit signal with at least one other transmit signal for transmission on at least one antenna.

13. The method of claim 12 further comprising adding a guard band to the plurality of OFDM frequency domain subcarriers.

14. The method of claim 1 wherein the plurality of OFDM frequency domain subcarriers is an OFDM symbol.

15. The method of claim 14 wherein modulated and symbol mapped data are used to form the OFDM symbol.

16. The method of claim 15 further comprising channelizing, scrambling, modulating and symbol mapping a data to generate the modulated and symbol mapped data used to form the OFDM symbol.

17. The method of claim 16 wherein the data is a Logical Control Channel or a Logical Traffic Channel.

18. The method of claim 17 wherein the Logical Control Channel is one of the following: a Broadcast Control Channel (BCCH), a Paging Control Channel (PCCH), a Multicast Control Channel (MCCH) or a Dedicated Control Channel (DCCH).

19. The method of claim 17 wherein the Logical Traffic Channel is one of the following: a Dedicated Traffic Channel (DTCH) or a Multicast Traffic Channel (MTCH).

20. The method of claim 16 wherein the data is an Uplink (UL) Transport Channel or a Downlink (DL) Transport Channel.

21. The method of claim 20 wherein the Uplink (UL) Transport Channel is one of the following: a Random Access Channel (RACH), a Request Channel (REQCH), a Uplink Shared Data Channel (UL-SDCH) or a physical layer (PHY) channel.

22. The method of claim 20 wherein the Downlink (DL) Transport Channel is one of the following: a Broadcast Channel (BCH), a Downlink Shared Data Channel (DL-SDCH) or a Paging Channel (PCH).

23. The method of claim 1 wherein Inverse Fast Fourier Transform (IFFT) is used for converting the plurality of subset subcarriers.

24. The method of claim 23 wherein a selective optimal mapping operator is used for recombining the plurality of time domain subwaveforms.

25. The method of claim 1 wherein the steps in claim 1 are executed in compliance with one of the following protocols: 3GPP Long Term Evolution (LTE), 3GPP2 Ultra Mobile Broadband (UMB) or wireless microwave access (WiMAX).

26. A transmit device for reducing peak-to-average power ratio (PAPR) in orthogonal frequency division multiplex (OFDM), the transmit device comprising:
a Form OFDM Symbol component for forming a plurality of OFDM frequency domain subcarriers;
an OFDM Symbol Partition component for mapping the plurality of OFDM frequency domain subcarriers into a plurality of subset subcarriers;
a Subsection IFFT component for converting the plurality of subset subcarriers into a plurality of time domain subwaveforms;
a Selective Optimal Combining component for recombining the plurality of time domain subwaveforms into two or more time domain combined signals with low Peak-to-Average Power Ratio (PAPR); and
a Frequency Upconversion component for frequency upconverting the two or more time domain combined signals to obtain a transmit signal.

27. The transmit device of claim 26 further comprising a Power Combining component for power combining the transmit signal with at least one other transmit signal for transmission on at least one antenna.

28. The transmit device of claim 27 wherein the transmit device is part of a multiple-input-multiple-output (MIMO) communication system.

29. The transmit device of claim 28 wherein a receiving component in the MIMO communication system performs channel estimation using the power combined transmit signals.

30. The transmit device of claim 26 wherein the plurality of subset subcarriers is partitioned into at least two processing paths to at least two transmit antennas in a MIMO or antenna array communication system, and wherein the at least two processing paths include performing the converting, recombining and frequency upconverting functions of claim 26.

31. The transmit device of claim 30 wherein the plurality of OFDM frequency domain subcarriers includes at least one pilot signal and the at least one pilot signal is confined to one of the plurality of subset subcarriers.

32. The transmit device of claim 31 wherein the one of the plurality of subset subcarriers is equally distributed among the at least two transmit antennas in the MIMO or antenna array communication system.

33. The transmit device of claim 26 wherein the plurality of OFDM frequency domain subcarriers includes at least one pilot signal.

34. The transmit device of claim 26 wherein the plurality of OFDM frequency domain subcarriers are all pilot signals.

35. The transmit device of claim 34 wherein the all pilot signals are equally distributed among a plurality of transmit antennas in a MIMO or antenna array communication system.

36. The transmit device of claim 26 further comprising amplifying the two or more time domain combined signals to transform the transmit signal to an amplified transmit signal.

37. The transmit device of claim 36 further comprising a Power Combining component for power combining the amplified transmit signal with at least one other transmit signal for transmission on at least one antenna.

38. The transmit device of claim 37 further comprising an Add Guardband component for adding a guard band to the plurality of OFDM frequency domain subcarriers.

39. The transmit device of claim 26 wherein the plurality of OFDM frequency domain subcarriers is an OFDM symbol.

40. The transmit device of claim 39 wherein modulated and symbol mapped data are used to form the OFDM symbol.

41. The transmit device of claim 40 further comprising
a channelization component for channelizing a data;
a scrambler for scrambling the channelized data; and
a modulator and symbol mapper for modulating and symbol mapping the channelized scrambled data to generate the modulated and symbol mapped data used to form the OFDM symbol.

42. The transmit device of claim 41 wherein the data is a Logical Control Channel or a Logical Traffic Channel.

43. The transmit device of claim 42 wherein the Logical Control Channel is one of the following: a Broadcast Control Channel (BCCH), a Paging Control Channel (PCCH), a Multicast Control Channel (MCCH) or a Dedicated Control Channel (DCCH).

44. The transmit device of claim 42 wherein the Logical Traffic Channel is one of the following: a Dedicated Traffic Channel (DTCH) or a Multicast Traffic Channel (MTCH).

45. The transmit device of claim 41 wherein the data is an Uplink (UL) Transport Channel or a Downlink (DL) Transport Channel.

46. The transmit device of claim 45 wherein the Uplink (UL) Transport Channel is one of the following: a Random Access Channel (RACH), a Request Channel (REQCH), a Uplink Shared Data Channel (UL-SDCH) or a physical layer (PHY) channel.

47. The transmit device of claim 45 wherein the Downlink (DL) Transport Channel is one of the following: a Broadcast Channel (BCH), a Downlink Shared Data Channel (DL-SDCH) or a Paging Channel (PCH).

48. The transmit device of claim 26 wherein Inverse Fast Fourier Transform (IFFT) is used for converting the plurality of subset subcarriers.

49. The transmit device of claim 48 wherein a selective optimal mapping operator is used for recombining the plurality of time domain subwaveforms.

50. The transmit device of claim 26 wherein the transmit device complies with one of the following protocols: a 3GPP Long Term Evolution (LTE), a 3GPP2 Ultra Mobile Broadband (UMB) or a wireless microwave access (WiMAX).

51. An apparatus for reducing peak-to-average power ratio (PAPR) in orthogonal frequency division multiplex (OFDM), the apparatus comprising:
means for forming a plurality of OFDM frequency domain subcarriers;
means for mapping the plurality of OFDM frequency domain subcarriers into a plurality of subset subcarriers;
means for converting the plurality of subset subcarriers into a plurality of time domain subwaveforms;
means for recombining the plurality of time domain subwaveforms into two or more time domain combined signals with low Peak-to-Average Power Ratio (PAPR); and
means for frequency upconverting the two or more time domain combined signals to obtain a transmit signal.

52. The apparatus of claim 51 further comprising means for power combining the transmit signal with at least one other transmit signal for transmission on at least one antenna.

53. The apparatus of claim 52 wherein the apparatus is part of a multiple-input-multiple-output (MIMO) communication system.

54. The apparatus of claim 53 wherein a receiving component in the MIMO communication system performs channel estimation using the power combined transmit signals.

55. The apparatus of claim 51 wherein the plurality of subset subcarriers is partitioned into at least two processing paths to at least two transmit antennas in a MIMO or antenna array communication system, and wherein the at least two processing paths include performing the converting, recombining and frequency upconverting functions of claim 51.

56. The apparatus of claim 55 wherein the plurality of OFDM frequency domain subcarriers includes at least one pilot signal and the at least one pilot signal is confined to one of the plurality of subset subcarriers.

57. The apparatus of claim 56 wherein the one of the plurality of subset subcarriers is equally distributed among the at least two transmit antennas in the MIMO or antenna array communication system.

58. The apparatus of claim 51 wherein the plurality of OFDM frequency domain subcarriers includes at least one pilot signal.

59. The apparatus of claim 51 wherein the plurality of OFDM frequency domain subcarriers are all pilot signals.

60. The apparatus of claim 59 wherein the all pilot signals are equally distributed among a plurality of transmit antennas in a MIMO or antenna array communication system.

61. The apparatus of claim 51 further comprising means for amplifying the two or more time domain combined signals to transform the transmit signal to an amplified transmit signal.

62. The apparatus of claim 61 further comprising means for power combining the amplified transmit signal with at least one other transmit signal for transmission on at least one antenna.

63. The apparatus of claim 62 further comprising means for adding a guard band to the plurality of OFDM frequency domain subcarriers.

64. The apparatus of claim 51 wherein the plurality of OFDM frequency domain subcarriers is an OFDM symbol.

65. The apparatus of claim 64 wherein modulated and symbol mapped data are used to form the OFDM symbol.

66. The apparatus of claim 65 further comprising
means for channelizing a data;
means for scrambling the channelized data; and
means for modulating and symbol mapping the channelized scrambled data to generate the modulated and symbol mapped data used to form the OFDM symbol.

67. The apparatus of claim 66 wherein the data is a Logical Control Channel or a Logical Traffic Channel.

68. The apparatus of claim 67 wherein the Logical Control Channel is one of the following: a Broadcast Control Channel (BCCH), a Paging Control Channel (PCCH), a Multicast Control Channel (MCCH) or a Dedicated Control Channel (DCCH).

69. The apparatus of claim 67 wherein the Logical Traffic Channel is one of the following: a Dedicated Traffic Channel (DTCH) or a Multicast Traffic Channel (MTCH).

70. The apparatus of claim 66 wherein the data is an Uplink (UL) Transport Channel or a Downlink (DL) Transport Channel.

71. The apparatus of claim 70 wherein the Uplink (UL) Transport Channel is one of the following: a Random Access Channel (RACH), a Request Channel (REQCH), a Uplink Shared Data Channel (UL-SDCH) or a physical layer (PHY) channel.

72. The apparatus of claim 70 wherein the Downlink (DL) Transport Channel is one of the following: a Broadcast Channel (BCH), a Downlink Shared Data Channel (DL-SDCH) or a Paging Channel (PCH).

73. The apparatus of claim 51 wherein Inverse Fast Fourier Transform (IFFT) is used for converting the plurality of subset subcarriers.

74. The apparatus of claim 73 wherein a selective optimal mapping operator is used for recombining the plurality of time domain subwaveforms.

75. The apparatus of claim 51 wherein the apparatus complies with one of the following protocols: a 3GPP Long Term Evolution (LTE), a 3GPP2 Ultra Mobile Broadband (UMB) or a wireless microwave access (WiMAX).

76. A computer-readable medium storing a computer program, wherein execution of the computer program is for:
forming a plurality of OFDM frequency domain subcarriers;
mapping the plurality of OFDM frequency domain subcarriers into a plurality of subset subcarriers;
converting the plurality of subset subcarriers into a plurality of time domain subwaveforms;
recombining the plurality of time domain subwaveforms into two or more time domain combined signals with low Peak-to-Average Power Ratio (PAPR); and
frequency upconverting the two or more time domain combined signals to obtain a transmit signal.

77. The computer-readable medium of claim 76 wherein execution of the computer program is also for power combining the transmit signal with at least one other transmit signal for transmission on at least one antenna.

78. The computer-readable medium of claim 77 wherein the at least one antenna is part of a multiple-input-multiple-output (MIMO) communication system.

79. The computer-readable medium of claim 78 wherein execution of the computer program is also for performing channel estimation using the power combined transmit signals.

80. The computer-readable medium of claim 76 wherein the plurality of subset subcarriers is partitioned into at least two processing paths to at least two transmit antennas in a MIMO or antenna array communication system, and wherein the at least two processing paths include the converting, recombining and frequency upconverting functions of claim 1.

81. The computer-readable medium of claim 80 wherein the plurality of OFDM frequency domain subcarriers includes at least one pilot signal and the at least one pilot signal is confined to one of the plurality of subset sub carriers.

82. The computer-readable medium of claim 81 wherein the one of the plurality of subset subcarriers is equally distributed among the at least two transmit antennas in the MIMO or antenna array communication system.

83. The computer-readable medium of claim 76 wherein the plurality of OFDM frequency domain subcarriers includes at least one pilot signal.

84. The computer-readable medium of claim 76 wherein the plurality of OFDM frequency domain subcarriers are all pilot signals.

85. The computer-readable medium of claim 84 wherein the all pilot signals are equally distributed among a plurality of transmit antennas in a MIMO or antenna array communication system.
